(19) United States
(12) Patent Application Publication
(10) Pub. No.: US 2021/0223435 A1
(43) Pub. Date: Jul. 22, 2021

(54) COLOR FILTER SUBSTRATE, METHOD FOR MANUFACTURING THE SAME AND DISPLAY DEVICE

(71) Applicants: BOE Technology Group Co., Ltd., Beijing (CN); Beijing BOE Display Technology Co., Ltd., Beijing (CN)

(72) Inventors: Lin WANG, Beijing (CN); Yongzhi SONG, Beijing (CN); Ruirui WANG, Beijing (CN); Huabin CHEN, Beijing (CN); Xingliang LI, Beijing (CN); Yang LIU, Beijing (CN); Yingqiang GAO, Beijing (CN)

(21) Appl. No.: 16/957,947

(22) PCT Filed: Dec. 20, 2019
(86) PCT No.: PCT/CN2019/126984

§ 371 Date: Jun. 25, 2020

(30) Foreign Application Priority Data
Jan. 2, 2019 (CN) 201910002764.7

(51) Int. Cl. G02B 1/00; G02B 5/20; B41M 3/00

(52) U.S. Cl. CPC G02B 1/005; G02B 5/206; G02B 2207/113; G02B 2207/101; B41M 3/003

(57) ABSTRACT

The present disclosure discloses a color filter substrate, a manufacture method thereof and a display device. The color filter substrate includes a substrate; and a light channel layer on a side of the substrate. The light channel layer includes a first photonic crystal layer and a second photonic crystal layer stacked with each other up and down. The light channel layer includes a plurality of light channel units formed by a periodic arrangement of three different primary-color light channel units. Each of the light channel units includes a photonic crystal block of the first photonic crystal layer and a photonic crystal block of the second photonic crystal layer with an orthographic projection of the photonic crystal block of the first photonic crystal layer on the substrate overlapping an orthographic projection of the photonic crystal block of the second photonic crystal layer on the substrate.

### CROSS-REFERENCE TO RELATED APPLICATIONS

The present disclosure claims the priority of Chinese Patent Application No. 201910002764.7, filed on Jan. 2, 2019, the content of which is incorporated herein by reference in its entirety.

### TECHNICAL FIELD

The disclosure relates generally to the field of display technology, and in particular to a color filter substrate, a method for manufacturing the same and a display device.

### BACKGROUND

A quantum dot with a particle size/diameter in a range of 1 nm to 10 nm is nano-scale semiconductor crystals capable of emitting light and is equivalent to 10 to 50 atoms in diameter. The quantum dot can emit bright visible light with pure spectrum color when being excited by light. A photonic crystal is a periodic dielectric structure with a photonic bandgap. Light waves with frequencies falling into the photonic bandgap cannot propagate in the photonic crystal due to the existence of the photonic bandgap, therefore the photonic crystal can selectively reflect light beams with specific frequencies, and light with frequencies out of the photonic bandgap can propagate in the photonic crystal.

### SUMMARY

As an aspect, a color filter substrate is provided in the present disclosure. color filter substrate includes a substrate; and a light channel layer on a side of the substrate. The light channel layer includes a first photonic crystal layer and a second photonic crystal layer stacked with each other up and down. The light channel layer includes a plurality of light channel units formed by a periodic arrangement of three different primary-color light channel units. Each of the light channel units includes one photonic crystal block of the first photonic crystal layer and one photonic crystal block of the second photonic crystal layer with an orthographic projection of the photonic crystal block of the first photonic crystal layer on the substrate overlapping an orthographic projection of the photonic crystal block of the second photonic crystal layer on the substrate. A photonic bandgap of the photonic crystal block of the first photonic crystal layer is different from a photonic bandgap of the photonic crystal block of the second photonic crystal layer. Each of the light channel units is configured to allow only one of three primary colors of light to pass through the light channel unit and to block the other two of the three primary colors of light.

In an embodiment, the first photonic crystal layer includes a plurality of photonic crystal blocks with photonic bandgaps in a first primary-color light region and a second primary-color light region respectively, and the second photonic crystal layer includes a plurality of photonic crystal blocks with photonic bandgaps in the second primary-color light region and a third primary-color light region respectively.

In an embodiment, the first photonic crystal layer includes the plurality of photonic crystal blocks with the photonic bandgaps in a blue light region and a red light region respectively, and the second photonic crystal layer includes the plurality of photonic crystal blocks with the photonic bandgaps in a red light region and a green light region respectively.

In an embodiment, the color filter substrate further includes a quantum dot material layer on a side of the light channel layer distal to the substrate and comprising red light quantum dot material regions and green light quantum dot material regions arranged periodically. The plurality of light channel units include a red light channel unit, a green light channel unit, and a blue light channel unit arranged periodically. An orthographic projection of the red light quantum dot material region on the substrate overlaps an orthographic projection of the red light channel unit on the substrate, and an orthographic projection of the green light quantum dot material region on the substrate overlaps an orthographic projection of the green light channel unit on the substrate.

In an embodiment, the color filter substrate further includes a reflection enhancement layer on a side of the quantum dot material layer distal to the substrate and comprising a third photonic crystal layer and a fourth photonic crystal layer stacked with each other up and down. The third photonic crystal layer includes a photonic crystal with a photonic bandgap in one of a red light region and a green light region, and the fourth photonic crystal layer includes a photonic crystal with a photonic bandgap in the other of a red light region and a green light region.

In an embodiment, the color filter substrate further includes a planarization layer between the quantum dot material layer and the reflection enhancement layer. The planarization layer covers the red light quantum dot material regions and the green light quantum dot material regions of the quantum dot material layer, and fills spaces except the red light quantum dot material regions and the green light quantum dot material regions to form a flat surface.

In an embodiment, photonic crystal blocks at an interface of two adjacent light channel units of the light channel layer permeate each other.

In an embodiment, each of the first photonic crystal layer and the second photonic crystal layer has a thickness in a range from 400 nm to 80 um.

In an embodiment, each of the third photonic crystal layer and the fourth photonic crystal layer has a thickness in a range from 400 nm to 80 um.

In an embodiment, the quantum dot material layer has a thickness in a range from 40 nm to 40 um.

In an embodiment, a material of the first photonic crystal layer, the second photonic crystal layer, the third photonic crystal layer and the fourth photonic crystal layer is monodisperse colloidal microspheres with high refractive indexes, and a red microsphere, green microsphere and blue microsphere have diameters in ranges of 190 nm to 210 nm, 160 nm to 180 nm, and 130 nm to 150 nm respectively.

As an aspect, a display device comprising a color filter substrate describe above and a blue light source on a side of the reflection enhancement layer distal to the substrate is provided.

As an aspect, a method for manufacturing a color filter substrate is provided. The method includes providing a substrate; and printing a light channel layer on the substrate. The light channel layer includes a first photonic crystal layer and a second photonic crystal layer stacked with each other up and down. The light channel layer includes a plurality of light channel units formed by a periodic arrangement of three different primary-color light channel units. Each of the light channel units includes one photonic crystal block of the first photonic crystal layer and one photonic crystal block of the second photonic crystal layer with an orthographic projection of the photonic crystal block of the first photonic crystal layer on the substrate overlapping an orthographic projection of the photonic crystal block of the second photonic crystal layer on the substrate. A photonic bandgap of the photonic crystal block of the first photonic crystal layer is different from a photonic bandgap of the photonic crystal block of the second photonic crystal layer, Each of the light channel units is configured to allow only one of three primary colors of light to pass through the light channel unit and to block the other two of the three primary colors of light.

In an embodiment, the method further includes printing a quantum dot material layer on a side of the light channel layer distal to the substrate. The quantum dot material layer includes red light quantum dot material regions and green light quantum dot material regions which are arranged periodically. An orthographic projection of the red light quantum dot material region on the substrate overlaps an orthographic projection of the red light channel unit of the light channel layer on the substrate, and an orthographic projection of the green light quantum dot material region on the substrate overlaps an orthographic projection of the green light channel unit of the light channel layer on the substrate.

In an embodiment, the method further includes coating a planarization layer on the quantum dot material layer. The planarization layer covers the red light quantum dot material regions and the green light quantum dot material regions of the quantum dot material layer, and fills spaces except the red light quantum dot material regions and the green light quantum dot material regions to form a flat surface.

In an embodiment, the method further includes sequentially printing a third photonic crystal layer and a fourth photonic crystal layer on a side of the planarization layer distal to the substrate. The third photonic crystal layer includes one photonic crystal with a photonic bandgap in one of a red light region and a green light region, and the fourth photonic crystal layer includes one photonic crystal with a photonic bandgap in the other of a red light region and a green light region.

In an embodiment, a material of the first photonic crystal layer, the second photonic crystal layer, the third photonic crystal layer and the fourth photonic crystal layer is monodisperse colloidal microspheres with high refractive index, and a red microsphere, green microsphere and blue microspheres have diameters in range of 190 nm to 210 nm, 160 nm to 180 nm, and 130 nm to 150 nm respectively.

### BRIEF DESCRIPTION OF THE DRAWINGS

Embodiments of the present disclosure will be illustrated in conjunction with the accompanying drawings, so that the above and other objects, features and advantages of the present disclosure will be more easily understood. Components in the drawings are intended to illustrate the principles of the present disclosure. In the drawings, the same or similar technical features or components will be denoted by the same or similar reference numerals.

FIG. 1 is a cross-sectional view showing a structure of a color filter substrate according to an embodiment of the disclosure;

FIG. 2 is a cross-sectional view showing various structures of a color filter substrate according to an embodiment of the disclosure; and

FIG. 3 is a flowchart showing a method for manufacturing a color filter substrate according to an embodiment of the disclosure.

### DETAILED DESCRIPTION

In the field of display technology, a technology of combining quantum dot material and a photonic crystal for display is developed. The quantum dot material is mixed into the photonic crystal. The quantum dot material is excited by white light to emit corresponding RGB light beams, and the photonic crystal plays the role of selective light transmission. However, the technology has obvious disadvantages. Since the quantum dot material is located inside the photonic crystal, a part of white light is selectively shielded or filtered by the photonic crystal before the white light reaches the quantum dot material, and only a small amount of corresponding light can pass through the photonic crystal and reach the quantum dot material, therefore the light utilization efficiency degrades.

In addition; when the quantum dot material is excited by blue light to emit light beams, and the light beams pass through the one-dimensional photonic crystals with detect states to selectively transmit R, G, or B light beams, since the one-dimensional photonic crystals are formed by alternately stacking two medium materials with different refractive indexes, generally at least ten layers are required to show the selectivity of the one-dimensional photonic crystals on the light beams, such a process is extremely difficulty. Moreover, the one-dimensional photonic crystals generally have angle dependence, that is, different colors can be seen from different perspectives.

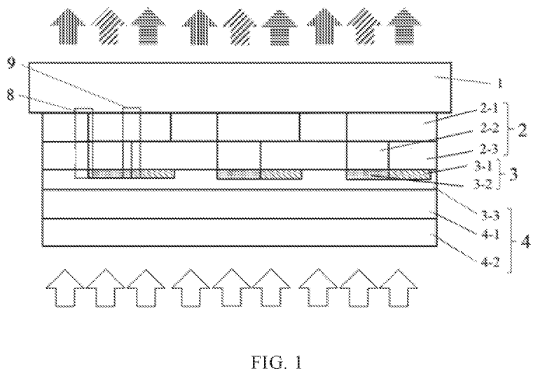

FIG. 1 is a cross-sectional view showing a structure of a color filter substrate according to an embodiment of the disclosure. As shown in FIG. 1, the color filter substrate includes a substrate 1 and a light channel layer 2, wherein the light channel layer is on a side of the substrate 1, includes a first photonic crystal layer and a second photonic crystal layer which are overlapped up and down, and is configured to include light channel units arranged in an array. In each of the light channel units, a photonic bandgap of the photonic crystal block of the first photonic crystal layer is different from a photonic bandgap of the photonic crystal block of the second photonic crystal layer. Each of the light channel units is configured to allow only one of the three primary color of light to pass through and to block the other two of the three primary color of light. The color filter substrate further includes a quantum dot material layer 3 on a side of the light channel layer 2 distal to the substrate 1 and including red light quantum dot material regions 3-1 and green light quantum dot material regions 3-2 which are arranged in an array. The red light quantum dot material region 3-1 and the green light quantum dot material region 3-2 correspond to a red light channel unit 5 and a green light channel unit 6 of the light channel layer 2 respectively.

According to the color filter substrate in the embodiment of the disclosure, the quantum dot material layer is outside the photonic crystal layer, and the quantum dot material layer only includes the red quantum dot luminescent material and green quantum dot luminescent material. In an embodiment, blue light can be used as an excitation light source, so as to reduce the use of blue light quantum dot material and the cost. Since the absorption of the photonic crystal on the three primary colors of light propagating in the light channels of the three primary colors (i.e., the red light channel, the blue light channel and the green light channel) is very poor, the transmittance of the color filter substrate can be remarkably improved.

In an embodiment, the first photonic crystal layer includes a plurality of photonic crystal blocks whose photonic bandgaps are respectively located in a first primary-color light region and a second primary-color light region. The second photonic crystal layer includes a plurality of photonic crystal blocks each of which has a photonic bandgap different from that of a photonic crystal block at a corresponding positon in the first photonic crystal layer. According to the arrangement, three primary colors of light emitted from the quantum dot material layer can be emitted to an upper side of the light channel layer 2 through the corresponding primary-color light channels after being filtered and reflected by the first photonic crystal layer and the second photonic crystal layer, thereby ensuring the monochromaticity of the primary colors of light (i.e., red light, blue light, and green light) and the intensity of the transmitted light.

The photonic crystal is designed as follows: the basic principle of a structure of the photonic crystal can be explained by Bragg diffraction, and a position of a theoretical reflection peak of the photonic crystal can be calculated according to the basic formula of Bragg diffraction:

λ_{Bragg}=2d\sqrt{n_{eff}²−sin²θ} (1.1)

n_{eff}²=nₛₚₕₑᵣₑ²fₛₕₚₑᵣₑ+nₐᵢᵣ²fₐᵢᵣ (1.2)

d=2\sqrt{⅔D} (1.3)

Where n_{eff} is an effective refractive index, nₛₚₕₑᵣₑ is a refractive index of the photonic crystal material, nₐᵢᵣ is a refractive index of the air, fₛₚₕₑᵣₑ is a ratio of a volume of the spherical nano material in the photonic crystal to a total volume of the photonic crystal, fₐᵢᵣ is a ratio of a volume of the air in the photonic crystal to the total volume of the photonic crystal, θ is an incident angle of a light beam, and D is a diameter of a microsphere.

If the effective refractive index of the photonic crystal is large enough, the influence of the incident angle of the light beam on the diffraction peak of the photonic crystal can be approximately ignored, therefore a material with a high refractive index greater than 2 can be used. Cadmium sulfide (with a refractive index of 2.51) nano-microspheres is taken as an example of the material of photonic crystals, particle sizes of the red, green and blue photonic crystals are in a range of 190 nm to 210 nm, 160 nm to 180 nm, and 130 nm to 150 nm respectively; and positions of the corresponding reflection peaks are located in a range of 610 nm to 680 nm (i.e., red light region), 520 nm to 580 nm (i.e., green light region), and 420 nm to 485 nm (i.e., blue light region) respectively.

In an embodiment, the color filter substrate further includes a reflection enhancement layer 4. The reflection enhancement layer 4 is located on a side of the quantum dot material layer distal to the substrate 1 and includes a third photonic crystal layer 4-1 and a fourth photonic crystal layer 4-2 which are sequentially stacked along a direction from the substrate 1 to the quantum dot material layer 3. The third photonic crystal layer 4-1 includes a photonic crystal with a photonic bandgap located in one of the red and green light regions, and the fourth photonic crystal layer 4-2 includes a photonic crystal with a photonic bandgap located in the other of the red and green light regions. With the arrangement of the reflection enhancement layer 4, the red light and the green light reflected downward by the quantum dot material layer cannot travel in the reflection enhancement layer 4, and are both reflected to the light-emitting surface of the light channel layer 2 along a light-emitting direction as shown in FIG. 1, therefore the utilization rate of the light and the intensity of the transmitted light can be obviously improved, and the light loss is reduced.

In an embodiment, the first photonic crystal layer includes a plurality of photonic crystal blocks with photonic bandgaps respectively located in a blue light region and a red light region; and the second photonic crystal layer includes a plurality of photonic crystal blocks with photonic bandgaps respectively located in a red light region and a green light region. Orthographic projections of the plurality of photonic crystal blocks of the first photonic crystal layer on the substrate 1 and orthographic projections of the plurality of photonic crystal blocks of the second photonic crystal layer on the substrate 1 overlap each other in one-to-one correspondence respectively.

In an embodiment, the reflection enhancement layer 4 further includes a planarization layer 3-3 located between the light channel layer 2 and the reflection enhancement layer 4. The planarization layer 3-3 covers the quantum dot material layer 3, that is, the planarization layer 3-3 covers the red light quantum dot material regions 3-1 and the green light quantum dot material regions 3-2, and fills the spaces except the red light quantum dot material regions 3-1 and the green light quantum dot material regions 3-2. The planarization layer 3-3 has a flat surface on an outer side of the quantum dot material layer 3 (that is, a side of the quantum dot material layer 3 distal to the substrate 1), which is beneficial to improving the transmittance of external light beams.

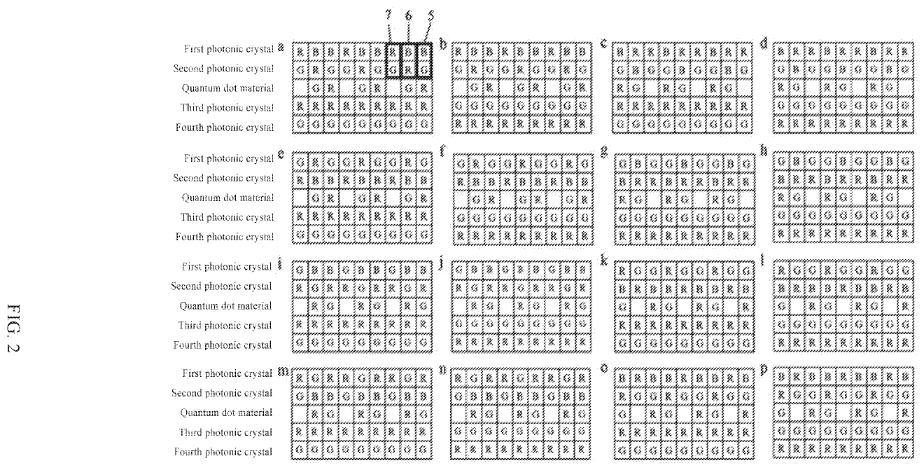

In an embodiment, as shown in FIGS. 1 and 2; the substrate 1 is a transparent glass substrate. The first photonic crystal layer of the light channel layer 2 includes a plurality of photonic crystal blocks R with a photonic bandgap in the red light region 2-2 and a plurality of photonic crystal blocks B with a photonic bandgap in the blue light region 2-1. The second photonic crystal layer includes a plurality of photonic crystal blocks G with a photonic bandgap in a green light region 2-3 and a plurality of photonic crystal blocks R with a photonic bandgap in a red light region 2-2. Two adjacent photonic crystal blocks (e.g., B, G blocks), along a light-emitting direction, of the first photonic crystal layer and the second photonic crystal layer have different colors of photonic bandgaps. In an embodiment, an orthographic projection of the photonic crystal block B of the first photonic crystal layer on the substrate overlaps an orthographic projection of a corresponding photonic crystal block G of the second photonic crystal layer on the substrate. The photonic crystal block B of the first photonic crystal layer and the corresponding photonic crystal block G of the second photonic crystal layer have photonic bandgaps in different color regions. For example, in the light channel unit 7, the photonic bandgap of the photonic crystal block R of the first photonic crystal layer corresponds to red light, and the photonic bandgap of the photonic crystal block G of the second photonic crystal layer corresponds to green light, so that after the RGB light beams incident into the light channel unit 7 pass through the first photonic crystal layer and the second photonic crystal layer, the red light and the green light are reflected back, and only the blue light can transmit through the light channel unit 7. In the light channel unit 6, the photonic bandgap of the photonic crystal block B of the first photonic crystal layer corresponds to blue light, and the photonic bandgap of the corresponding photonic crystal block R of the second photonic crystal layer corresponds to red light, so that after the RGB light beams incident into the light channel unit 6 pass through the first photonic crystal layer and the second photonic crystal layer, the blue light and the red light are reflected back, and only the green light can transmit through the light channel unit 6. In the light channel unit 5, the photonic bandgap of the photonic crystal block B of the first photonic crystal layer corresponds to blue light, and the photonic bandgap of the photonic crystal block G of the second photonic crystal layer corresponds to green light, so that after the RGB light beams incident into the light channel unit 5 pass through the first photonic crystal layer and the second photonic crystal layer, the blue light and the green light are reflected back, and only the red light can transmit through the light channel unit 5. With the array arrangement of the photonic crystals, the color light beams of RGB and RGB etc. can transmit through the transparent glass plate, so that the red light channel unit 5, the green light channel unit 6 and the blue light channel unit 7 can be formed correspondingly, thereby achieving selective transmission of light beams.

Herein, one photonic crystal block of the first and second photonic crystal layers refers to a photonic crystal block whose photonic bandgap is located in the blue light region, the red light region, or the green light region. In other words, the first photonic crystal layer includes a plurality of photonic crystal blocks with different photonic handgaps (e.g., a plurality of photonic crystal blocks B and a plurality of photonic crystal blocks R), and the second photonic crystal layer includes a plurality of photonic crystal blocks with different photonic handgaps (e.g., a plurality of photonic crystal blocks G and a plurality of photonic crystal blocks R). A size of one photonic crystal block of the first photonic crystal layer and the second photonic crystal layer is related to a resolution of a display device.

One red light channel unit 5 includes two photonic crystal blocks B and G. One green light channel unit 6 includes two photonic crystal blocks B and R. One blue light channel unit 7 includes two photonic crystal blocks R and G (or photonic crystal blocks R, G).

One red light channel unit 5 is equivalent to one red sub-pixel, one green light channel unit 6 is equivalent to one green sub-pixel, and one blue light channel unit 7 is equivalent to one blue sub-pixel. One red light channel unit 5, one green light channel unit 6 and one blue light channel unit 7 constitute one pixel.

The photonic crystal has extremely weak absorption to light beams propagating in the corresponding primary-color light channel. For example, in a blue light channel unit, the red light and the green light are reflected, and almost no blue light is absorbed, therefore the blue light is transmitted to a maximum degree, and the transmittance of the color filter substrate can be obviously improved.

In a case where the blue light serves as an excitation light source, the quantum dot material layer may reduce or not include the blue light quantum dot material, only the red light quantum dot material in the red light quantum dot material regions 3-1 and the green light quantum dot material in the green light quantum dot material regions 3-2 are retained, thereby reducing the cost. The empty spaces where the blue light quantum dot material should be formed but not formed therein can be filled with the planarization layers 3-3, and the material of the planarization layer is further coated on an outer side of the quantum dot material layer, thereby facilitating the incidence of parallel light beams.

Unlike the first photonic crystal layer and the second photonic crystal layer, the third photonic crystal layer 4-1 of the reflection enhancement layer 4 is formed of a single or one photonic crystal block, and the fourth photonic crystal layer 4-2 is formed of a single or one photonic crystal block. For example, the third photonic crystal layer 4-1 is formed of a single photonic crystal block having a photonic bandgap in the red light region, and the fourth photonic crystal layer 4-2 is formed of a single photonic crystal block having a photonic bandgap in the green light region.

Since the photonic bandgaps of the photonic crystals of the third photonic crystal layer 4-1 and the fourth photonic crystal layer 4-2 are located in the red light region and the green light region respectively, the resulted effect is that the reflection enhancement layer 4 can only transmit light having a wavelength in the blue light region, i.e., blue light, so that the third photonic crystal layer 4-1 and the fourth photonic crystal layer 4-2 form a blue light channel, and the red and green light beams cannot propagate in the third photonic crystal layer 4-1 and the fourth photonic crystal layer 4-2. When the blue light transmits through the reflection enhancement layer 4 to excite the red light quantum dot material and the green light quantum dot material, a part of the red light and the green light may travel along a return direction (i.e., a direction towards the reflection enhancement layer 4 or a direction opposite to the light-emitting direction). Due to the bandgap characteristic of photonic crystal in the reflection enhancement layer 4, the red light and the green light cannot propagate in the reflection enhancement layer 4 along the return direction, and both of the red light and the green light are reflected to the quantum dot material layer 3 along a direction towards the light channel layer 2 or the light-emitting direction, thereby obviously improving the utilization rate of light and the intensity of the transmitted light, and reducing the loss of light. In addition, due to the bandgap characteristic of the photonic crystal, the reflected red light and the reflected green light above (from the light channel layer 2) and below (from the reflection enhancement layer 4) the quantum dot material layer 3 can only propagate in the red light channel unit 5 and the green light channel unit 6 of the light channel layer 2 respectively, the blue light can only propagate in the blue light channel unit 7, and the redundant stray light cannot propagate in the light channel unit, thereby obviously improving the purity of the transmitted light.

In addition, as shown in FIG. 1, since the photonic crystal blocks at interfaces 8 and 9 of different primary-color light channel in the first photonic crystal layer and the second photonic crystal layer has different photonic bandgaps. For example, a photonic crystal block R having a photonic bandgap in a red light region, a photonic crystal block B having a photonic bandgap in a blue light region, and a photonic crystal block G having a photonic bandgap in a green light region permeate each other at the channel interface 8. For another example, the photonic crystal block R having a photonic bandgap in a red light region, the photonic crystal block B having a photonic bandgap in a blue light region, and the photonic crystal block G having a photonic bandgap in a green light region permeate with each other at the channel interface 9, as shown in FIG. 1, so that all three primary colors of light are reflected at the channel interface 8 or 9, thereby reducing the transmittance of light and simplifying the process of the color filter substrate, because it is unnecessary to form a shielding film for shielding an opaque region of a TFT display device.

The embodiment takes the blue light source as the excitation light source for illustration. It is noted that in the present disclosure, a red light source or a green light source may also serve as the excitation light source.

When the red light source or the green light source serves as the excitation light source, the bandgaps of the plurality of photonic crystal blocks in the first photonic crystal layer, the bandgaps of the plurality of photonic crystal blocks in the second photonic crystal layer, the bandgap of the single photonic crystal in the third photonic crystal layer and the bandgap of the single photonic crystal in the fourth photonic crystal layer can be adaptively changed.

FIG. 2 shows cross-sectional views showing various structures of a color filter substrate according to an embodiment of the disclosure. Figures a to p in FIG. 2 respectively show various combinations of the colors of the photonic crystals of light channel layer 2 and the reflection enhancement layer 4 and the colors of the quantum dot material layer 3 in a composite color filter substrate. The combinations can be implemented to form different primary-color light channels, thereby achieving the technical effects described above.

In an embodiment, each of the first and second photonic crystal layers has a thickness in a range from 400 nm to 80 um.

In an embodiment, each of the third photonic crystal layer 4-1 and the fourth photonic crystal layer 4-2 has a thickness in a range from 400 nm to 80 um.

In an embodiment, the quantum dot material layer 3 has a thickness in a range from 40 nm to 40 um.

In an embodiment, a material of all photonic crystals (i.e., the photonic crystal blocks in the first photonic crystal layer, the photonic crystal blocks in the second photonic crystal layer, the photonic crystal block in the third photonic crystal layer and the photonic crystal block in the fourth photonic crystal layer) is monodisperse colloidal microspheres with high refractive index with the particle sizes of the red, green and blue microsphere in ranges of 190 nm to 210 nm, 160 nm to 180 nm, and 130 nm to 150 nm, respectively.

In an embodiment, the red light, the green light and the blue light has wavelengths in ranges of 610 nm to 680 nm, 520 nm to 580 nmm, and 420 nm to 485 nm, respectively.

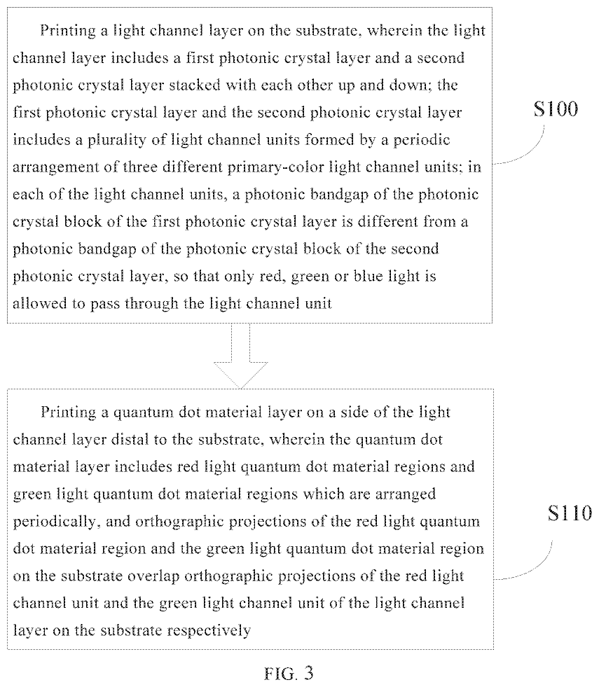

FIG. 3 is a flowchart showing a method for manufacturing a color filter substrate according to an embodiment of the disclosure. As shown in FIG. 3, the method includes steps S100 and S110.

At S100: firstly, a light channel layer 2 is printed on a glass substrate 1 through an ink-jet printing process. The light channel layer 2 includes a first photonic crystal layer and a second photonic crystal layer which overlap each other up and down. The light channel layer 2 includes a plurality of light channel units formed by array arrangement or periodic arrangement of three different primary-color light channel units. Each of the light channel units includes a photonic crystal block (i.e., one photonic crystal block) of the first photonic crystal layer and a corresponding photonic crystal block (i.e., one corresponding photonic crystal block) of the second photonic crystal layer. The photonic crystal block of the second photonic crystal layer is located on a side of the photonic crystal block of the first photonic crystal layer distal to the glass substrate 1, and the orthographic projection of the photonic crystal block of the first photonic crystal layer on the glass substrate 1 and the orthographic projection of the corresponding photonic crystal block of the second photonic crystal layer on the glass substrate 1 completely overlap each other. In each of the light channel units, a photonic bandgap of a photonic crystal block of the first photonic crystal layer is different from a photonic bandgap of a corresponding photonic crystal block of the second photonic crystal layer. A combination of the photonic bandgap of the photonic crystal block of the first photonic crystal layer and the photonic bandgap of the corresponding photonic crystal block of the second photonic crystal layer makes each of the light channel units only allow red light, green light or blue light to pass through the light channel unit.

At S110: secondly, a quantum dot material layer 3 is ink-jet printed on a side of the light channel layer 2 distal to the glass substrate 1. The quantum dot material layer includes red light quantum dot material regions 3-1 and green light quantum dot material regions 3-2 which are arranged periodically or arranged in an array. The red light quantum dot material region 3-1 corresponds to the red light channel unit 5 of the light channel layer 2. An orthographic projection of the red light quantum dot material region 3-1 on the glass substrate 1 completely overlaps an orthographic projection of the red light channel unit 5 on the glass substrate 1. The green quantum dot material region 3-2 corresponds to the green light channel units 6 of the light channel layer 2. An orthographic projection of the green light quantum dot material region 3-2 on the glass substrate 1 completely overlaps an orthographic projection of the green light channel unit 6 on the glass substrate 1. No quantum dot material is formed at spaces of the quantum dot material layer 3 corresponding to the blue light channel unit 7.

According to the method for manufacturing the color filter substrate, the rapid large-area construction of the photonic crystal light channel is realized through the ink-jet printing technology, therefore the process difficulty is reduced, industrial production is realized easily, and the transmittance of the composite color filter substrate and the purity of the transmitted light can be significantly improved.

The method further includes coating a planarization layer 3-3 on the quantum dot material layer 3 to planarize a surface of the quantum dot material layer 3. The planarization layer 3-3 covers the red light quantum dot material in the red light quantum dot material regions 3-1 and the green light quantum dot material in the green light quantum dot material regions 3-2, and covers spaces except the red light quantum dot material regions 3-1 and the green light quantum dot material regions 3-2, that is, covers the blue light channel units 7 on which no quantum dot material is formed.

In an embodiment, the method further includes ink-jet printing a reflection enhancement layer 4 on the planarization layer. The reflection enhancement layer 4 includes a third photonic crystal layer 4-1 and a fourth photonic crystal layer 4-2 which are stacked with each other. The third photonic crystal layer 4-1 includes one piece of photonic crystal block having a photonic bandgap in one of the red and green light regions, and the fourth photonic crystal layer 4-2 includes one piece of photonic crystal block having a photonic bandgap in the other of the red and green light regions.

The nano-microspheres with high refractive index may serve as the ink-jet printing material for constructing the photonic crystals, therefore the visual angle difference of the photonic crystals can be avoided, and the observation angle can be improved.

In an embodiment, the material for ink-jet printed photonic crystals is monodisperse colloidal nanospheres with a high refractive index greater than 2, such as cadmium sulfide, cuprous oxide, titanium oxide, zinc oxide, zinc sulfide and the like. The nano-microsphere can be manufactured by a hydrothermal method, sol-gel method, emulsion polymerization and the like.

The nano-microspheres with a high refractive index are dispersed in a mixture of a high-boiling-point assistant, ethanol, glycerol, a surfactant, a defoaming agent, an adhesive, a regulator and deionized water, and the monodisperse colloid nano-microspheres can be obtained through an ultrasonic dispersion treatment.

A photoluminescence quantum dot material such as CdSe, CdTe, graphene and the like may serves as the quantum dot material. A wavelength of blue light matched with the quantum dot material is in a range from 440 nm to 460 nm, the light-emitting peak of the green light quantum dot material is in a range from 510 nm to 540 nm, and the light-emitting peak of the red light quantum dot material is in a range from 630 nm to 670 nm. A blue backlight (e.g., a blue electroluminescent light source) may serve as a light source in the present disclosure.

After the ink-jet printing and the coating of the planarization layer are finished, a heat treatment with a heating temperature of 100° C. to 120° C. is performed on the color filter substrate for 20 to 30 seconds to completely remove the solvent in the color film.

The present disclosure also provides a display device, which includes a light source (e.g., a blue light source) and the color filter substrate disposed along a light-emitting direction of the blue light source according to any of the above technical solutions.

According to the description of the color filter substrate and the manufacturing method thereof, the obtained display device can obtain corresponding technical effects, and details are not repeated here.

It should be understood that the above implementations are merely exemplary embodiments for the purpose of illustrating the principles of the present disclosure, however, the present disclosure is not limited thereto. It will be apparent to those skilled in the art that various changes and modifications can be made without departing from the spirit and spirit of the present disclosure, which are also to be regarded as the scope of the present disclosure.

1. A color filter substrate, comprising:
a substrate; and
a light channel layer on a side of the substrate, wherein
the light channel layer comprises a first photonic crystal layer and a second photonic crystal layer stacked with each other up and down,
the light channel layer comprises a plurality of light channel units formed by a periodic arrangement of three different primary-color light channel units,
each of the light channel units comprises one photonic crystal block of the first photonic crystal layer and one photonic crystal block of the second photonic crystal layer with an orthographic projection of the photonic crystal block of the first photonic crystal layer on the substrate overlapping an orthographic projection of the photonic crystal block of the second photonic crystal layer on the substrate,
a photonic bandgap of the photonic crystal block of the first photonic crystal layer is different from a photonic bandgap of the photonic crystal block of the second photonic crystal layer, and each of the light channel units is configured to allow only one of three primary colors of light to pass through the light channel unit and to block the other two of the three primary colors of light.

2. The color filter substrate according to claim 1, wherein
the first photonic crystal layer comprises a plurality of photonic crystal blocks with photonic bandgaps in a first primary-color light region and a second primary-color light region respectively, and
the second photonic crystal layer comprises a plurality of photonic crystal blocks with photonic bandgaps in the second primary-color light region and a third primary-color light region respectively.

3. The color filter substrate according to claim 2, wherein
the first photonic crystal layer comprises the plurality of photonic crystal blocks with the photonic bandgaps in a blue light region and a red light region respectively, and
the second photonic crystal layer comprises the plurality of photonic crystal blocks with the photonic bandgaps in a red light region and a green light region respectively.

4. The color filter substrate according to claim 3, further comprising: a quantum dot material layer on a side of the light channel layer distal to the substrate and comprising red light quantum dot material regions and green light quantum dot material regions arranged periodically, wherein
the plurality of light channel units comprise a red light channel unit, a green light channel unit, and a blue light channel unit arranged periodically,
an orthographic projection of the red light quantum dot material region on the substrate overlaps an orthographic projection of the red light channel unit on the substrate, and
an orthographic projection of the green light quantum dot material region on the substrate overlaps an orthographic projection of the green light channel unit on the substrate.

5. The color filter substrate according to claim 4, further comprising: a reflection enhancement layer on a side of the quantum dot material layer distal to the substrate and comprising a third photonic crystal layer and a fourth photonic crystal layer stacked with each other up and down, wherein
the third photonic crystal layer comprises a photonic crystal with a photonic bandgap in one of a red light region and a green light region, and
the fourth photonic crystal layer comprises a photonic crystal with a photonic bandgap in the other of a red light region and a green light region.

6. The color filter substrate according to claim 5, further comprising: a planarization layer between the quantum dot material layer and the reflection enhancement layer, wherein the planarization layer covers the red light quantum dot material regions and the green light quantum dot material regions of the quantum dot material layer, and fills spaces except the red light quantum dot material regions and the green light quantum dot material regions to form a flat surface.

7. The color filter substrate according to claim 1, wherein
photonic crystal blocks at an interface of two adjacent light channel units of the light channel layer permeate each other.

8. The color filter substrate according to claim 1, wherein
each of the first photonic crystal layer and the second photonic crystal layer has a thickness in a range from 400 nm to 80 um.

9. The color filter substrate according to claim 5, wherein
each of the third photonic crystal layer and the fourth photonic crystal layer has a thickness in a range from 400 nm to 80 um.

10. The color filter substrate according to claim 4, wherein
the quantum dot material layer has a thickness in a range from 40 nm to 40 um.

11. The color filter substrate according to claim 5, wherein
a material of the first photonic crystal layer, the second photonic crystal layer, the third photonic crystal layer and the fourth photonic crystal layer is monodisperse colloidal microspheres with high refractive indexes, and
a red microsphere, green microsphere and blue microsphere have diameters in ranges of 190 nm to 210 nm, 160 nm to 180 nm, and 130 nm to 150 nm respectively.

12. A display device comprising a color filter substrate according to claim 1 and a blue light source on a side of the light channel layer distal to the substrate.

13. A method for manufacturing a color filter substrate, comprising:
providing a substrate; and
printing a light channel layer on the substrate, such that
the light channel layer comprises a first photonic crystal layer and a second photonic crystal layer stacked with each other up and down,
the light channel layer comprises a plurality of light channel units formed by a periodic arrangement of three different primary-color light channel units,
each of the light channel units comprises one photonic crystal block of the first photonic crystal layer and one photonic crystal block of the second photonic crystal layer with an orthographic projection of the photonic crystal block of the first photonic crystal layer on the substrate overlapping an orthographic projection of the photonic crystal block of the second photonic crystal layer on the substrate,
a photonic bandgap of the photonic crystal block of the first photonic crystal layer is different from a photonic bandgap of the photonic crystal block of the second photonic crystal layer, and each of the light channel units is configured to allow only one of three primary colors of light to pass through the light channel unit and to block the other two of the three primary colors of light.

14. The method according to claim 13, further comprising: printing a quantum dot material layer on a side of the light channel layer distal to the substrate, such that the quantum dot material layer comprises red light quantum dot material regions and green light quantum dot material regions which are arranged periodically, wherein printing the light channel layer on the substrate comprises: forming the plurality of light channel units comprising a red light channel unit, a green light channel unit, and a blue light channel unit arranged periodically, such that
an orthographic projection of the red light quantum dot material region on the substrate overlaps
an orthographic projection of the red light channel unit of the light channel layer on the substrate, and
an orthographic projection of the green light quantum dot material region on the substrate overlaps an orthographic projection of the green light channel unit of the light channel layer on the substrate.

15. The method according to claim 14, further comprising: coating a planarization layer on the quantum dot material layer, such that
the planarization layer covers the red light quantum dot material regions and the green light quantum dot material regions of the quantum dot material layer, and fills spaces except the red light quantum dot material regions and the green light quantum dot material regions to form a flat surface.

16. The method according to claim 15, further comprising: sequentially printing a third photonic crystal layer and a fourth photonic crystal layer on a side of the planarization layer distal to the substrate, such that
the third photonic crystal layer comprises one photonic crystal with a photonic bandgap in one of a red light region and a green light region, and
the fourth photonic crystal layer comprises one photonic crystal with a photonic bandgap in the other of a red light region and a green light region.

17. The method according to claim 16, wherein
a material of the first photonic crystal layer, the second photonic crystal layer, the third photonic crystal layer and the fourth photonic crystal layer is monodisperse colloidal microspheres with high refractive index, and
a red microsphere, green microsphere and blue microspheres have diameters in range of 190 nm to 210 nm, 160 nm to 180 nm, and 130 nm to 150 nm respectively.
